(19) United States
(12) Patent Application Publication
(10) Pub. No.: US 2011/0262062 A1
(43) Pub. Date: Oct. 27, 2011

(54) MANUFACTURING METHOD OF ARC-SHAPED RAIL

(75) Inventors: Satoru Ichihashi, Hagagun (JP); Kenzo Takeda, Hagagun (JP)

(73) Assignee: HONDA MOTOR CO., LTD., Tokyo (JP)

(21) Appl. No.: 13/084,936

(22) Filed: Apr. 12, 2011

(30) Foreign Application Priority Data
Apr. 21, 2010 (JP) 2010-097753

(51) Int. Cl. F16C 29/04; B21D 37/00; B21D 7/00

(52) U.S. Cl. 384/55; 72/70; 72/476

(57) ABSTRACT

A manufacturing method for appropriately manufacturing an arc-shaped rail that is C-shaped in cross section includes: a first process of forming one side wall 313 and one of circumferential wall portions 312 by bending a ring R of a thin metal plate by spinning, the circumferential wall portions 312 being portions on both sides of a width direction of the inner circumferential wall or the outer circumferential wall divided by a slit 314; a second process of forming the other side wall 313 and the other circumferential wall portion 312 by spinning using a plurality of cores 41 to 43 so as to envelop the cores 41 to 43, the cores 41 to 43 being obtained by dividing a core in a width direction to not more than a width of the slit 314; and a third process of separately extracting the cores 41 to 43 from the slit 314.

### BACKGROUND OF THE INVENTION

1. Field of the Invention

The present invention relates to a manufacturing method of an arc-shaped rail.

2. Description of the Related Art

Conventionally, for example, an arc-shaped rail used in a walking assisting device is known (e.g., see Japanese Patent Application Laid-Open No. 2009-247605). The walking assisting device includes a seat member which a user sits astride, and a pair of left and right leg links which support the seat member from below. Each leg link is connected to the seat member via a curved guiding mechanism so as to be swingable in a forward-backward direction.

The curved guiding mechanism includes an arc-shaped rail and a slider. The arc-shaped rail is substantially C-shaped in cross section, and is connected to a back end of a support frame of the seat member via a forward-backward spindle so as to be swingable in a lateral direction. The slider has a roller contacting an inner circumferential surface of the arc-shaped rail, and is fixed to an upper end of the leg link.

### SUMMARY OF THE INVENTION

Conventionally, the arc-shaped rail is formed by extrusion molding using aluminum, for weight reduction. However, the arc-shaped rail formed using aluminum, though lightweight, has a problem of a poor strength.

In view of this, there is a technique of manufacturing the arc-shaped rail by spinning using a thin metal plate such as a high-tension material (high-tensile steel plate).

In this case, however, the following problem arises. In order to manufacture the arc-shaped rail having a substantially C-shaped cross section using a thin metal plate, the arc-shaped rail needs to be manufactured by using a core so as to envelop the core. However, since the rail is arc-shaped, the arc-shaped rail is deformed when extracting the core from an opening of a longitudinal end of the rail.

The core may be extracted by cutting the arc-shaped rail in the longitudinal direction, but this requires a troublesome operation of later restoring the cut arc-shaped rail by welding or the like.

The present invention has an object of providing a manufacturing method of an arc-shaped rail whereby an arc-shaped rail that is C-shaped in cross section can be appropriately manufactured using a thin metal plate.

A first aspect of the present invention is a manufacturing method of an arc-shaped rail that is C-shaped in cross section, the arc-shaped rail having: an arc-shaped inner circumferential wall and outer circumferential wall; a pair of side walls connecting the inner circumferential wall and the outer circumferential wall at side edges thereof; and a slit formed at a center of the inner circumferential wall or the outer circumferential wall along a longitudinal direction, wherein the arc-shaped rail is formed by bending a ring of a thin metal plate by spinning, wherein a width of each of circumferential wall portions at both sides of a width direction of the inner circumferential wall or the outer circumferential wall divided by the slit is not more than a width of the slit, and wherein the manufacturing method includes: a first process of forming one of the side walls and one of the circumferential wall portions by bending the ring of the thin metal plate by spinning; a second process of forming an other one of the side walls and an other one of the circumferential wall portions by spinning using a plurality of cores so as to envelop the plurality of cores, the plurality of cores being obtained by dividing a core in a width direction to not more than the width of the slit; a third process of separately extracting the plurality of cores from the slit; and a fourth process of cutting the ring of the thin metal plate to a desired length in a circumferential direction.

In the manufacturing method of the arc-shaped rail according to the first aspect of the present invention, the core is divided in the width direction to not more than the width of the slit, and therefore can be extracted from the slit. This prevents the arc-shaped rail from being deformed when extracting the core. Hence, the arc-shaped rail that is C-shaped in cross section can be appropriately manufactured using the thin metal plate.

A second aspect of the present invention is a manufacturing method of an arc-shaped rail that is C-shaped in cross section, the arc-shaped rail having: an arc-shaped inner circumferential wall and outer circumferential wall; a pair of side walls connecting the inner circumferential wall and the outer circumferential wall at side edges thereof; and a slit formed at a center of the inner circumferential wall or the outer circumferential wall along a longitudinal direction, wherein the arc-shaped rail is formed by bending a ring of a thin metal plate by spinning using a circumferentially divided core so that the arc-shaped rail has a desired inside dimension, and wherein the manufacturing method includes: a first process of forming one of the side walls and one of circumferential wall portions by bending the ring of the thin metal plate by spinning, the circumferential wall portions being portions on both sides of a width direction of the inner circumferential wall or the outer circumferential wall divided by the slit; and a second process of forming an other one of the side walls and an other one of the circumferential wall portions by spinning using a plurality of cores so as to envelop the plurality of cores, the plurality of cores being obtained by dividing the core in a width direction to not more than a width of the slit.

In the manufacturing method of the arc-shaped rail according to the second aspect of the present invention, also, the core is divided in the width direction to not more than the width of the slit, and therefore can be extracted from the slit. This prevents the arc-shaped rail from being deformed when extracting the core. Hence, the arc-shaped rail that is C-shaped in cross section can be appropriately manufactured using the thin metal plate.

Moreover, by using the core, the arc-shaped rail can be accurately manufactured to have a desired inside dimension. This allows a slider to smoothly slide inside the arc-shaped rail.

In the present invention, the plurality of cores may include a first core, a second core, and a middle core, the first core being placed within a space defined by the one side wall and the one circumferential wall portion formed in the first process, the second core being used for forming the other side wall and the other circumferential wall portion in the second process, and the middle core being placed between the first core and the second core, wherein, in the second process, the other side wall and the other circumferential wall portion are formed by bending the ring so as to be along an outer surface of the second core.

An arc-shaped rail manufactured by the manufacturing method according to the present invention described above has a slider having a roller slides inside.

A manufacturing device using the manufacturing method according to the present invention is a manufacturing device that manufactures an arc-shaped rail by bending a ring of a thin metal plate by spinning, the arc-shaped rail being C-shaped in cross section and having: an arc-shaped inner circumferential wall and outer circumferential wall; a pair of side walls connecting the inner circumferential wall and the outer circumferential wall at side edges thereof; and a slit formed at a center of the inner circumferential wall or the outer circumferential wall along a longitudinal direction, the manufacturing device including: an external die in which the ring is placed; a core placed so that the ring is sandwiched between the core and the external die; and a spinning roller movable by an arm mechanism, wherein the core is divided into a plurality of cores in a width direction, wherein the side walls and circumferential wall portions are formed by bending the ring by the spinning roller so as to envelop the plurality of cores, the circumferential wall portions being portions on both sides of a width direction of the inner circumferential wall or the outer circumferential wall divided by the slit, and wherein the plurality of cores are separately extractable from the slit.

A core according to the present invention is a core used for manufacturing an arc-shaped rail that is C-shaped in cross section, the arc-shaped rail having: an arc-shaped inner circumferential wall and outer circumferential wall; a pair of side walls connecting the inner circumferential wall and the outer circumferential wall at side edges thereof; and a slit formed at a center of the inner circumferential wall or the outer circumferential wall along a longitudinal direction, the core including: a first core that, after one of the side walls and one of circumferential wall portions are formed, is placed within a space defined by the side wall and the circumferential wall portion, upon forming an other one of the side walls and an other one of the circumferential wall portions, the circumferential wall portions being portions on both sides of a width direction of the inner circumferential wall or the outer circumferential wall divided by the slit; a second core that is used for forming the other side wall and the other circumferential wall portion; and a middle core that is placed between the first core and the second core.

### BRIEF DESCRIPTION OF THE DRAWINGS

FIG. 1 is an explanatory view showing a walking assisting device that uses an arc-shaped rail in a first embodiment of the present invention.

FIG. 2 is an explanatory view showing the arc-shaped rail in the first embodiment.

FIG. 3 is a sectional view showing a manufacturing device of the arc-shaped rail in the first embodiment.

FIG. 4 is a perspective view showing an external die in the first embodiment.

FIG. 5 is an explanatory view showing a process of forming one side wall in a first process in the first embodiment.

FIG. 6 is an explanatory view showing a process of forming one circumferential wall portion in the first process in the first embodiment.

FIG. 7 is an explanatory view showing a process of forming the other side wall in a second process in the first embodiment.

FIG. 8 is an explanatory view showing a process of forming the other circumferential wall portion in the second process in the first embodiment.

FIG. 9 is an explanatory view showing a third process in the first embodiment.

FIG. 10 is a sectional view showing a manufacturing device of an arc-shaped rail in a second embodiment of the present invention.

FIG. 11 is a sectional view showing cores used in a manufacturing method of an arc-shaped rail in a third embodiment of the present invention.

### DESCRIPTION OF THE PREFERRED EMBODIMENTS

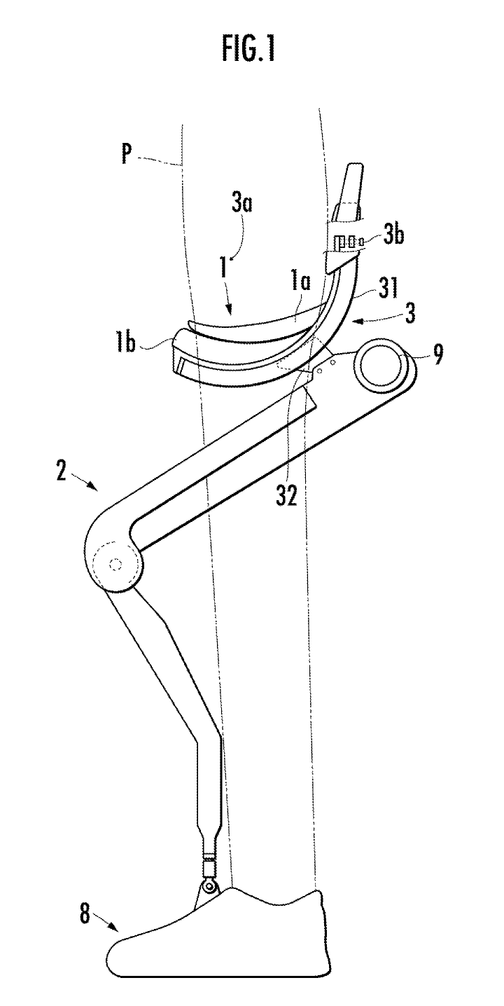

The following describes a manufacturing method of an arc-shaped rail, a manufacturing device and a core using the manufacturing method, and an arc-shaped rail manufactured by the manufacturing device in a first embodiment of the present invention with reference to FIGS. 1 to 9.

An arc-shaped rail in the first embodiment is used in a walking assisting device shown in FIG. 1. The walking assisting device includes a seat member 1 which a user P sits astride, and a pair of left and right leg links 2 which support the seat member 1 from below, as shown in FIG. 1.

Each leg link 2 is connected to the seat member 1 via a curved guiding mechanism 3 described later, so as to be swingable in a forward-backward direction. A shoe 8 which the user P wears on his/her left or right foot is connected to a lower end of the leg link 2.

Each leg link 2 carries a drive source 9. Rotation of the drive source 9 exerts a force on the leg link 2 in a stretching direction, thereby generating bearing power (hereafter referred to as weight relief assist power) for bearing at least a part of the weight of the user P. The weight relief assist power generated by the leg link 2 is transmitted to the body of the user P via the seat member 1, as a result of which a load on the leg of the user P is reduced.

The curved guiding mechanism 3 includes an arc-shaped rail 31 connected to a rising part at a back end of a support frame 1b of the seat member 1 via a forward-backward spindle 3b so as to be swingable in a lateral direction, and a slider 32 fixed to an upper end of the leg link 2. A center of curvature 3a of the arc of the arc-shaped rail 31 is located above an upper surface of a seat 1a of the seat member 1.

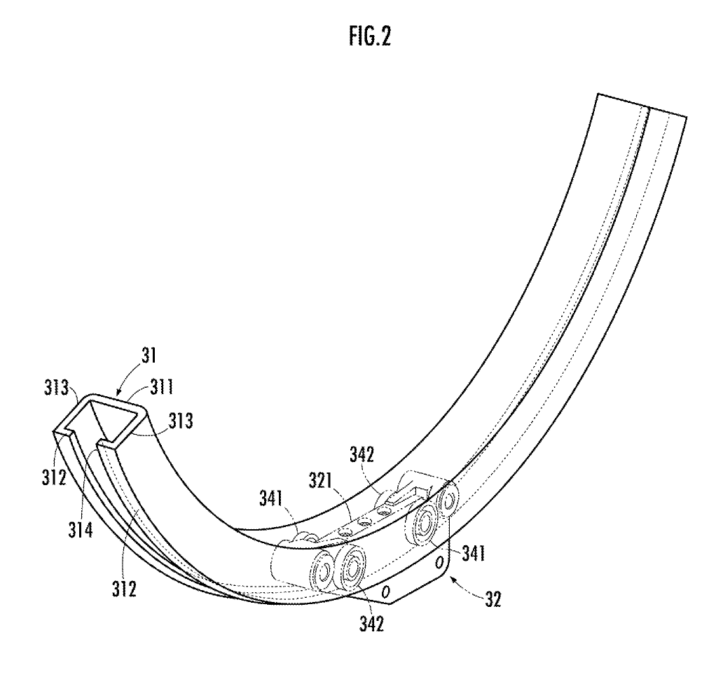

The following describes the curved guiding mechanism 3 in detail, with reference to FIG. 2. The arc-shaped rail 31 has: an inner circumferential wall 311 on an inner circumference closer to the center of curvature 3a; an outer circumferential wall 312 on an outer circumference farther from the center of curvature 3a; a pair of side walls 313, 313 connecting the inner circumferential wall 311 and the outer circumferential wall 312 on both sides of a groove width direction (lateral direction) that is orthogonal to a longitudinal direction of the arc-shaped rail 31 (forward-backward direction) and a curvature radius direction of the arc (upward-downward direction); and a slit 314 formed at a center of a width of the outer circumferential wall 312. The arc-shaped rail 31 is C-shaped in cross section. The slit 314 divides the outer circumferential wall 312 into two outer circumferential walls 312, which correspond to circumferential wall portions in the present invention.

The slider 32 has an insert 321 that is inserted inside the arc-shaped rail 31 through the slit 314. The insert 321 includes two inner rotors 341 that rollably contact the inner circumferential wall 311 of the arc-shaped rail 31 from inside, and two outer rotors 342 that rollably contact the outer circumferential wall 312 from inside. These four rotors 341 and 342 enable the slider 32 to slide along the arc-shaped rail 31. Note that each of the rotors 341 and 342 is composed of a deep groove ball bearing.

By forming the arc-shaped rail 31 to have a C-shaped cross section, a foreign matter such as trousers can be reliably kept from entering into the arc-shaped rail 31. This prevents the foreign matter from being caught in the contact parts of the rotors 341 and 342, ensuring that each leg link 2 swings smoothly.

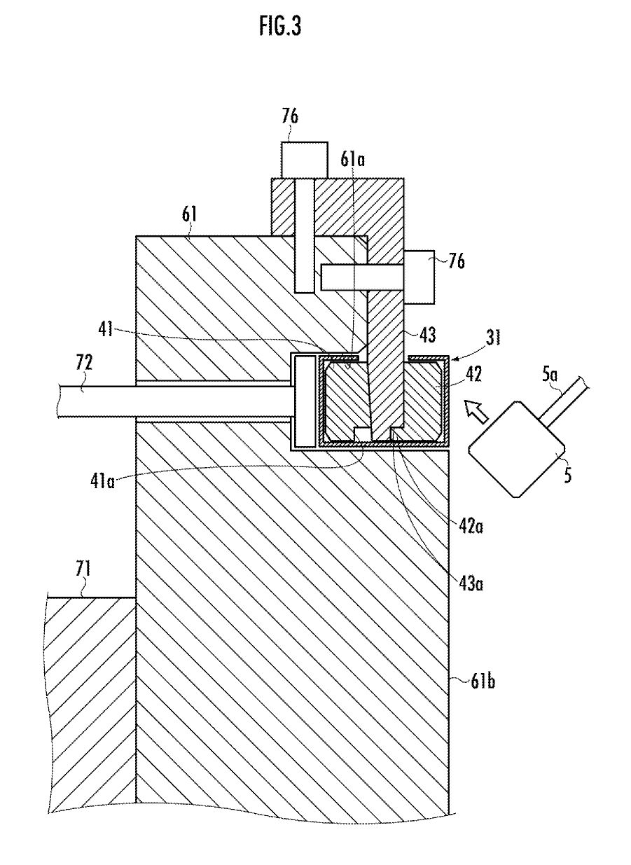

The following describes a manufacturing device and a manufacturing method of the arc-shaped rail 31 in the first embodiment, with reference to FIGS. 3 to 5.

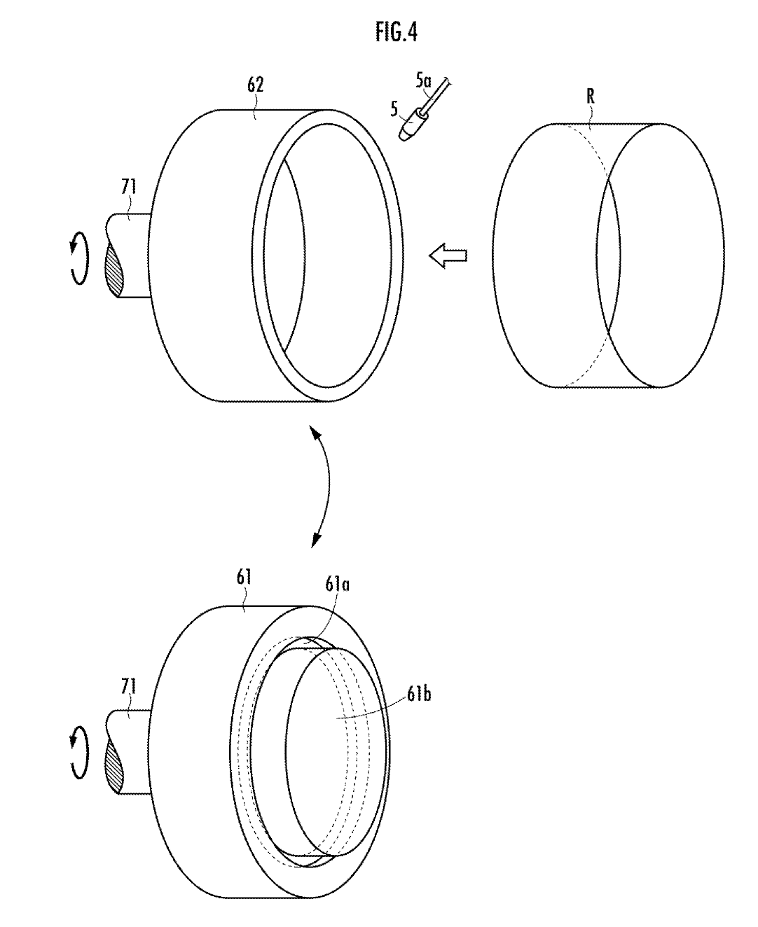

As shown in FIGS. 3 and 4, the manufacturing device of the arc-shaped rail 31 in the first embodiment manufactures the arc-shaped rail 31 by bending a ring R of a thin metal plate (see FIG. 4) by spinning. The manufacturing device includes: an external die 61 rotated by a drive source not shown; a core divided into three cores, namely, two side cores of a first side core 41 and a second side core 42 and a middle core 43 that is sandwiched between the side cores 41 and 42 and presses the side cores 41 and 42 toward the ring R; and an arm mechanism 5a that freely moves a spinning roller 5 of various types attached to its tip.

The external die 61 has an annular groove 61a formed on its side surface opposite to a rotation shaft 71 which is connected to the drive source. Moreover, a cylindrical protrusion 61b where a part inside the annular groove 61a protrudes in a rotation shaft direction is formed on the side surface of the external die 61 on which the annular groove 61a is formed.

A knockout pin 72 for ejecting the arc-shaped rail 31 is provided in the annular groove 61a.

Each of the cores 41 to 43 is divided into a pair of semicircular rings, which are combined to form a ring. The middle core 43 is L-shaped in cross section, and is fixed to the external die 61 by a bolt 76. An overhang 42a that overhangs toward the middle core 43 is formed at a radially inner end of a side surface of the second side core 42 in contact with the middle core 43. A receptacle 43a for receiving the overhang 42a of the second side core 42 is formed at a radially inner end of the middle core 43. In addition, a notch 41a for receiving the overhang 42a is provided in the first side core 41.

A surface of the middle core 43 in contact with the first side core 41 is gradually inclined toward the second side core 42 in a radially inward direction. In accordance with this, a surface of the first side core 41 in contact with the middle core 43 is gradually inclined toward the middle core 43 in the radially inward direction. This allows the middle core 43 to be easily extracted from between the side cores 41 and 42.

The external die 61 is removable from the rotation shaft 71, and a closed-bottom cylindrical first process die 62 described later can be attached to the rotation shaft 71 instead of the external die 61.

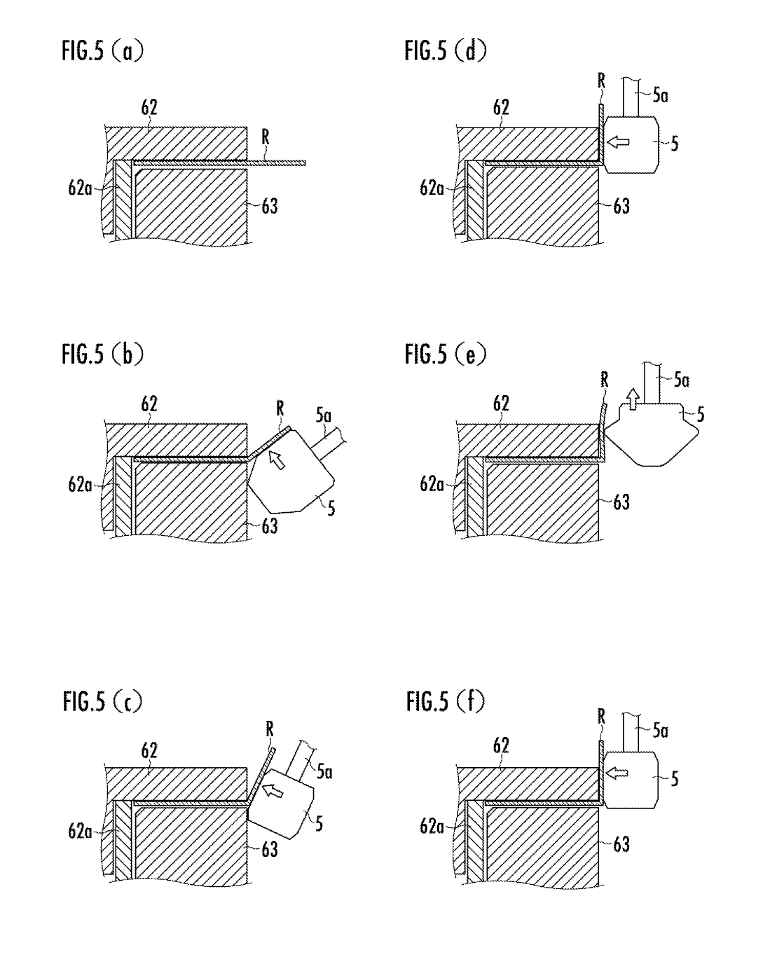

The following describes a manufacturing process of the arc-shaped rail 31, with reference to FIGS. 5 to 9. A first process of forming one side wall 313 and one outer circumferential wall 312 connected to this side wall 313 in the arc-shaped rail 31 by bending one side edge of the ring R is performed first. In detail, first, the external die 61 is removed from the rotation shaft 71, and the rotation shaft 71 is attached to an outer bottom surface of the closed-bottom cylindrical first process die 62 (see FIG. 4).

Next, the ring R of a thin metal plate is placed in the first process die 62. The ring R is pressed to an inner circumferential surface of the first process die 62 by a tailstock member 63, thereby fixing the ring R to the first process die 62. Here, one side edge of the ring R is exposed to outside the first process die 62, as shown in FIG. 5(a). Note that, in FIG. 5, a spacer 62a is disposed at the bottom of the first process die 62 in order to adjust an extent of exposure of the ring R.

Following this, to form one side wall 313, the spinning roller 5 having a truncated cone tip is used to bend one side edge of the ring R at a predetermined angle toward an open end surface of the first process die 62 (i.e., in a radially outward direction), as shown in FIG. 5(b). Then, the spinning roller 5 of a cylindrical shape is used to gradually bend the side edge of the ring R, thereby forming one side wall 313 along the open end surface of the first process die 62, as shown in FIGS. 5(c) and 5(d).

Next, the spinning roller 5 of a substantially triangular pyramid shape is moved by the arm mechanism 5a in the radially outward direction to perform ironing on the one side wall 313, as shown in FIG. 5(e). After such internal stress relaxation, the spinning roller 5 of a cylindrical shape is used to perform surface press of pressing the one side wall 313, thereby correcting warping of the one side wall 313, as shown in FIG. 5(f).

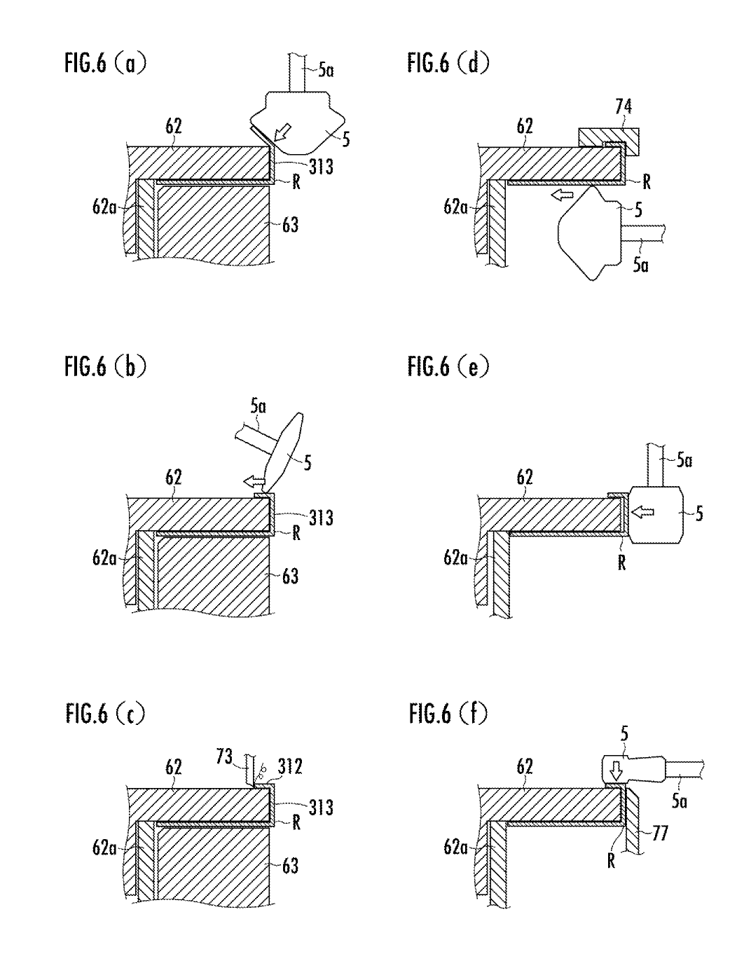

The following describes a process of bending one outer circumferential wall 312, with reference to FIG. 6. First, the spinning roller 5 of a substantially triangular pyramid shape is used to bend a radially outer part of the one outer circumferential wall 312 extending radially outwardly over an outer circumferential surface of the first process die 62, at a predetermined angle toward the outer circumferential surface of the first process die 62, as shown in FIG. 6(a).

Next, the spinning roller 5 of a disc shape is used to perform ironing on the part bent at the predetermined angle toward the outer circumferential surface of the first process die 62, while deforming the bent part along the outer circumferential surface of the first process die 62, thereby forming the one outer circumferential wall 312 (one circumferential wall portion), as shown in FIG. 6(b). Then, a side edge of the one outer circumferential wall 312 is cut by a cutter 73 so that the one outer circumferential wall 312 has a predetermined width, as shown in FIG. 6(c).

After this, a substantially L-shaped fixing member 74 for fixing the one outer circumferential wall 312 to the first process die 62 is attached to the first process die 62, and also the tailstock member 63 is removed and the spinning roller 5 of a substantially triangular pyramid shape is used to perform ironing on an unbent part of the ring R, as shown in FIG. 6(d).

Following this, to handle a situation where the process of FIG. 6(d) causes a change in inclination of the one side wall 313 and the one outer circumferential wall 312, the fixing member 74 is removed and the spinning roller 5 is used to perform angle correction of the one side wall 313 and the one outer circumferential wall 312, as shown in FIGS. 6(e) and 6(f). Note that the one side wall 313 is pressed by a pressing member 77 during angle correction of the one outer circumferential wall 312, as shown in FIG. 6(f).

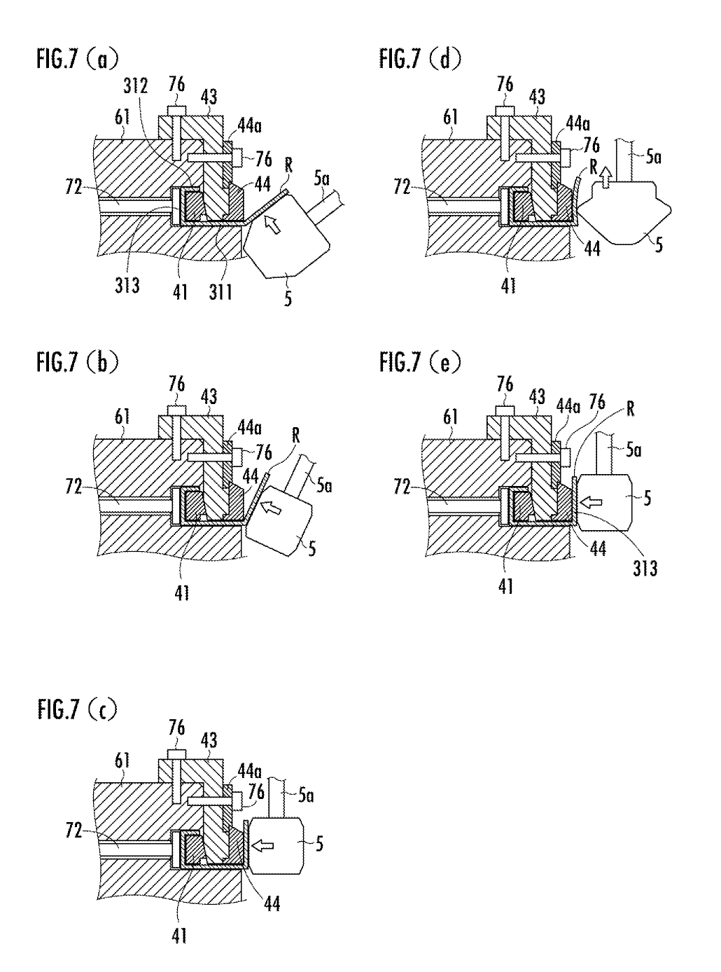

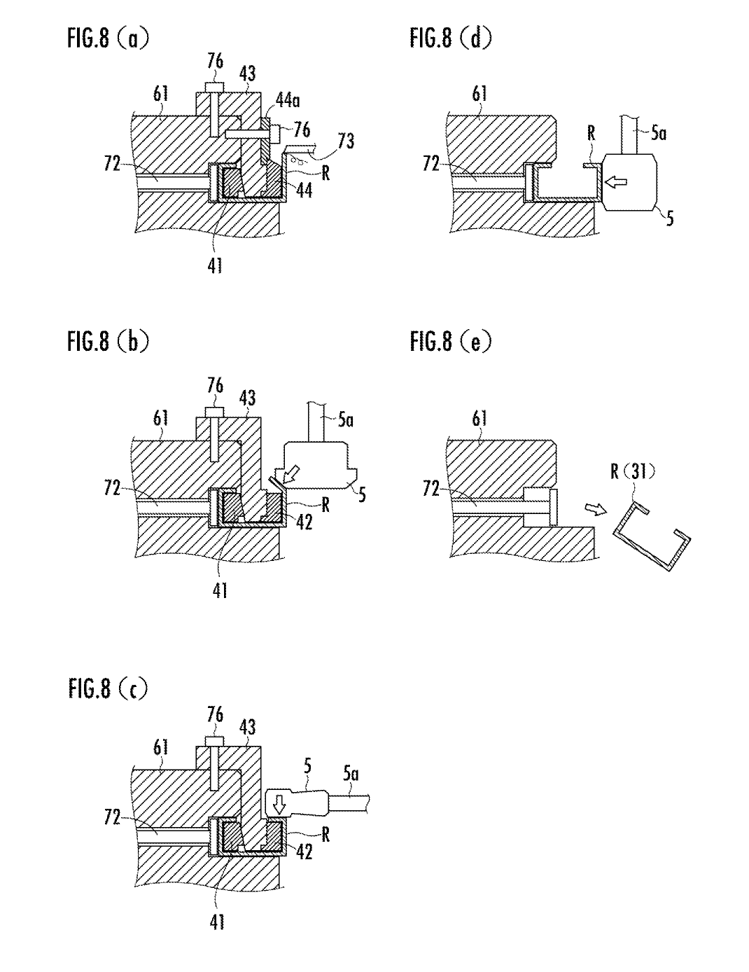

The following describes a process of forming the other side wall 313 and the other outer circumferential wall 312, with reference to FIGS. 7 and 8. First, the ring R having one side wall 313 and one outer circumferential wall 312 formed in the first process shown in FIGS. 5 and 6 is placed in the external die 61. To do so, the first process die 62 is removed from the rotation shaft 71, and the external die 61 is attached to the rotation shaft 71.

Next, one side wall 313 and one outer circumferential wall 312 formed in the ring R are inserted into the annular groove 61a of the external die 61. The first side core 41 is inserted into a space defined by the one side wall 313 and the one outer circumferential wall 312 formed in the ring R, and the middle core 43 is overlaid on the first side core 41.

Further, a side wall core 44 is overlaid on the middle core 43. The side wall core 44 differs from the second side core 42 in that its outer circumferential surface is inclined so that the side wall core 44 gradually increases in diameter toward the middle core 43, but the other structure of the side wall core 44 is the same as that of the second side core 42.

The side wall core 44 is fixed to the middle core 43 by a locking member 44a that engages with the outer circumferential surface of the side wall core 44. This prevents the side wall core 44 from rattling against the middle core 43, when forming the other side wall 313.

Next, the spinning roller 5 having a truncated cone tip is used to bend the other side edge of the ring R extending from a circumferential surface of the protrusion 61b of the external die 61 in the rotation shaft direction, at a predetermined angle toward a side surface of the side wall core 44, as shown in FIG. 7(a). Following this, the spinning roller 5 of a cylindrical shape is used to bend the other side edge of the ring R bent at the predetermined angle, so as to be along the side surface of the side wall core 44, as shown in FIGS. 7(b) and 7(c).

Then, the spinning roller 5 of a substantially triangular pyramid shape is used to perform ironing on the other side wall 313 formed in the above manner, thereby attaining an appropriate internal stress, as shown in FIG. 7(d). Moreover, the spinning roller 5 of a cylindrical shape is used to perform surface press for correcting warping, as shown in FIG. 7(e).

The following describes a process of forming the other outer circumferential wall 312, with reference to FIG. 8. First, the other side edge of the ring R is cut by the cutter 73 to a predetermined width, as shown in FIG. 8(a). Next, the locking member 44a, the middle core 43, and the side wall core 44 are removed from the external die 61 in this order, the second side core 42 is placed in contact with an inner surface of the other side wall 313, and the middle core 43 is disposed between the side cores 41 and 42. The middle core 43 is fixed to the external die 61 by the bolt 76, and the overhang 42a of the second side core 42 is locked into the receptacle 43a of the middle core 43, so that the second side core 42 is kept from slipping off.

Moreover, since the second side core 42 contacts the other side wall 313, the second side core 42 can be prevented from rattling in the rotation shaft direction, with there being no need for locking by a locking member as in the case of the side wall core 44.

The spinning roller 5 is used to bend a part of the ring R extending radially outwardly over the outer circumferential surface of the second side core 42 toward the outer circumferential surface of the second side core 42, thereby forming the other outer circumferential wall 312 (the other circumferential wall portion), as shown in FIGS. 8(b) and 8(c). Subsequently, after removing the cores, the spinning roller 5 of a cylindrical shape is used to perform angle correction of the other side wall 313, as shown in FIG. 8(d). Then, the ring R is ejected from the annular groove 61a by the knockout pin 72. In a fourth process, the ring R is cut to a desired length in a circumferential direction, as a result of which the arc-shaped rail 31 having a C-shaped cross section is completed.

In the case where the arc-shaped rail 31 having a C-shaped cross section is formed by above-mentioned spinning using a core, the arc-shaped rail 31 can be accurately manufactured to have a desired inside dimension, thereby enabling the slider to favorably slide inside the arc-shaped rail 31. However, since the core is enveloped, it is difficult to extract one core that is undivided in the width direction.

As a method of extracting such a core, for example, the arc-shaped rail 31 in a ring form may be cut to a desired length in the width direction so that the core is extracted from a cut end surface of the arc-shaped rail 31. However, since the core is curved in an arc shape, too, it is extremely difficult to extract the core from inside the arc-shaped rail 31, and there is a possibility that the arc-shaped rail 31 is deformed.

Alternatively, the arc-shaped rail 31 may be cut in the circumferential direction to extract the core. This, however, requires a troublesome operation of later restoring the arc-shaped rail 31 by welding.

In view of this, the core in the first embodiment is divided into three cores, namely, the two side cores of the first side core 41 and the second side core 42 and the middle core 43 that is sandwiched between the two side cores 41 and 42 in the width direction.

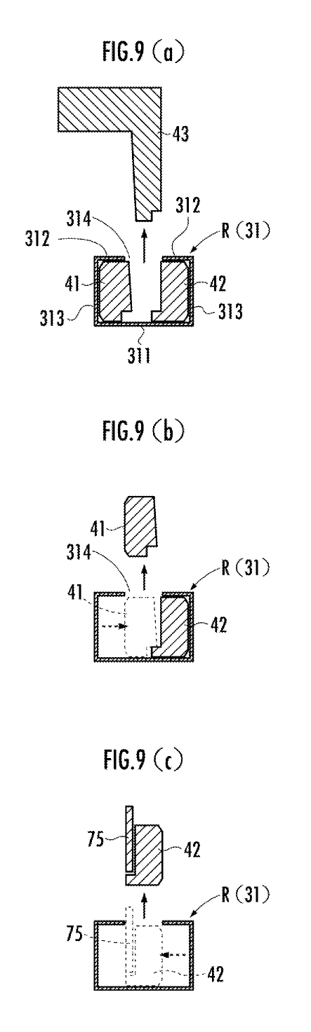

As a result, the cores can be extracted in the following manner. After extracting the middle core 43 from the slit 314 as shown in FIG. 9(a), the arc-shaped rail 31 is tilted so that the second side core 42 is positioned below, to overlay the first side core 41 on the second side core 42. Hence, the first side core 41 can be extracted from the slit 314 of the arc-shaped rail 31, as shown in FIG. 9(b).

Since the inside of the arc-shaped rail 31 has a larger space as a result of extracting the first side core 41 and the middle core 43, the second side core 42 can be easily extracted from the slit 314 without deforming the arc-shaped rail 31, as shown in FIG. 9(c). When doing so, a thin-plate auxiliary tool 75 may be inserted from the slit 314 so that the second side core 42 carried on the auxiliary tool 75 is extracted from the slit 314, as shown in FIG. 9(c).

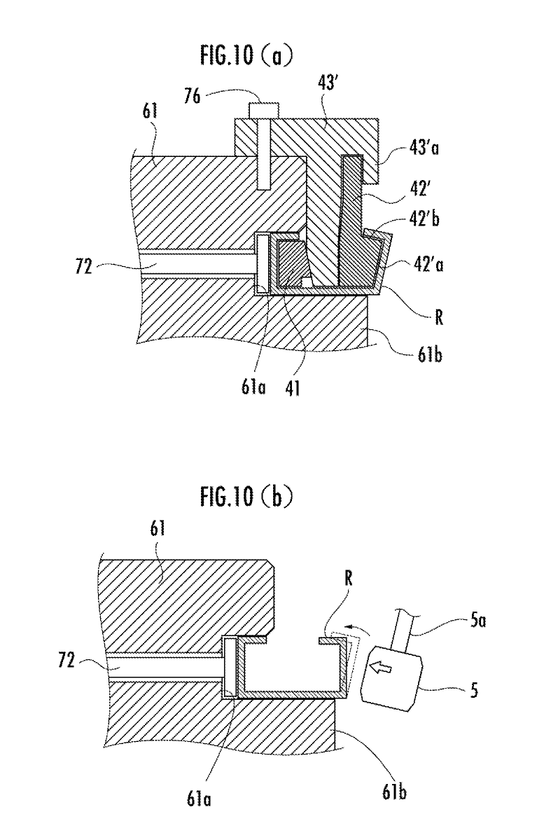

The following describes a second embodiment of a manufacturing method of an arc-shaped rail according to the present invention, with reference to FIG. 10. The manufacturing method of the arc-shaped rail in the second embodiment differs from the first embodiment in shapes of a second side core 42′ and a middle core 43′ and in a second process, but the other structure of the second embodiment is the same as that of the first embodiment.

In the manufacturing method of the arc-shaped rail in the second embodiment, the second side core 42′ is substantially L-shaped in cross section, and an outer side surface 42′a of the second side core 42′ for forming the other side wall 313 of the arc-shaped rail 31 is inclined so as to, in the radially outward direction, gradually overhang outward in the width direction.

Moreover, a step surface 42′b of the second side core 42′ connected to a radially outer edge of the outer side surface 42′a is inclined so that an angle between the step surface 42′b and the outer side surface 42′a is an angle between the other side wall 313 and the other circumferential wall portion 312 of the arc-shaped rail 31.

A surface of the middle core 43′ in contact with the second side core 42′ has an inclined surface that gradually inclines toward the first side core 41 in the radially inward direction. In accordance with this inclined surface, a surface of the second side core 42′ in contact with the middle core 43′ also has an inclined surface that gradually inclines toward the middle core 43′ in the radially inward direction. This allows the middle core 43′ to be easily extracted from between the side cores 41 and 42′.

The middle core 43′ is fixed to the external die 61 by the bolt 76, and has an engaging part 43′a that engages with a radially outer end of the second side core 42′. This engaging part 43′a prevents the second side core 42′ from slipping off.

The following describes the manufacturing method of the arc-shaped rail 31 in the second embodiment. The manufacturing method in the second embodiment is the same as that in the first embodiment, except the second process. In the second process in the second embodiment, after bending the other side wall 313 and the other circumferential wall portion 312 by the spinning roller 5 along the outer side surface 42′a and the step surface 42′b of the second side core 42′, the middle core 43′, the first side core 41, and the second side core 42′ are extracted form the slit 314 in this order.

Then, the other side wall 313 is bent by the spinning roller 5 to have a desired angle with the inner circumferential wall 311, as shown in FIG. 10(b). The subsequent fourth process is the same as that in the first embodiment.

In the manufacturing method of the arc-shaped rail 31 in the second embodiment, the other side wall 313 and the other circumferential wall portion 312 can be formed using only the second side core 42′, without using the side wall core 44 as in the first embodiment. This makes it unnecessary to replace the core as in the first embodiment, contributing to easier manufacturing of the arc-shaped rail 31 and a shorter time required for manufacturing.

Moreover, since the step surface 42′b is inclined, the second side core 42′ can be extracted easily, without the other circumferential wall portion 312 of the ring R being stuck with the step surface 42′b.

In addition, when extracting the cores 41, 42′, and 43′ from the slit 314, the angle between the other side wall 313 and the inner circumferential wall 311 is larger than the desired angle, and accordingly the slit 314 has a slightly larger width. This eases the extraction of each of the cores 41, 42′, and 43′ from the slit 314 in the second embodiment. Note that, in the present invention, the concept “width of the slit” is defined to include not only the width of the slit upon completion of the arc-shaped rail 31, but also the width of the slit in a process of extracting the core from the slit as in the state of FIG. 10(a) in the second embodiment.

Though the two side cores of the first side core 41 and the second side core 42 (42′) are used in the second process in the first and second embodiments, the number of side cores in the second process is not limited to two, as the advantageous effects of the present invention can still be achieved with only the second side core 42 (42′). However, by using the first side core 41 together, the deformation of one side wall 313 and one outer circumferential wall 312 and the like in the second process in the present invention shown in FIGS. 7 and 8 can be more easily suppressed, and therefore the arc-shaped rail 31 can be accurately manufactured.

Though the arc-shaped rail 31 has the slit 314 formed in the outer circumferential wall 312 in the first and second embodiments, this is not a limit for the present invention, which is equally applicable to the arc-shaped rail 31 having the slit 314 formed in the inner circumferential wall 311. In this case, instead of the protrusion 61b in the first embodiment, an annular protrusion 61b where a part that is radially more outward than the annular groove 61a protrudes in the rotation shaft direction is formed on the side surface of the external die 61 on which the annular groove 61a is formed.

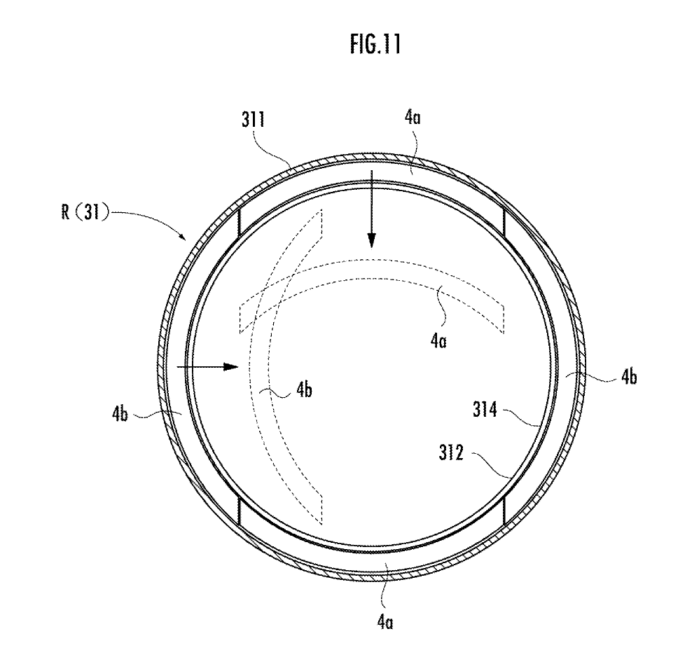

Here, the core needs to be extracted from the slit 314 formed in the inner circumferential wall 311, in the radially inward direction of the arc-shaped rail 31. This can be done, for example, in the following manner. As shown in FIG. 11 as a third embodiment of the present invention, the core is divided into four cores in the circumferential direction, and both circumferential end surfaces of a pair of facing cores 4a are parallel and both circumferential end surfaces of a remaining pair of cores 4b are along the circumferential end surfaces of the cores 4a.

In such a case, after the pair of cores 4a are extracted from the slit 314 in the radially inward direction of the ring R along the circumferential end surfaces, the remaining pair of cores 4b are extracted from the slit 314. Since the cores 4a and 4b are kept from being trapped with each other circumferentially, the cores 4a and 4b can be easily extracted from inside the ring R.

What is claimed is:

1. A manufacturing method of an arc-shaped rail that is C-shaped in cross section, the arc-shaped rail having: an arc-shaped inner circumferential wall and outer circumferential wall; a pair of side walls connecting the inner circumferential wall and the outer circumferential wall at side edges thereof; and a slit formed at a center of the inner circumferential wall or the outer circumferential wall along a longitudinal direction,
wherein the arc-shaped rail is formed by bending a ring of a thin metal plate by spinning, using a circumferentially divided core, and
wherein the manufacturing method comprises:
a first process of forming one of the side walls and one of circumferential wall portions by bending the ring of the thin metal plate by spinning, the circumferential wall portions being portions on both sides of a width direction of the inner circumferential wall or the outer circumferential wall divided by the slit;
a second process of forming an other one of the side walls and an other one of the circumferential wall portions by spinning using a plurality of cores so as to envelop the plurality of cores, the plurality of cores being obtained by dividing the core in a width direction to not more than a width of the slit;
a third process of separately extracting the plurality of cores from the slit; and
a fourth process of cutting the ring of the thin metal plate to a desired length in a circumferential direction.

2. A manufacturing method of an arc-shaped rail that is C-shaped in cross section, the arc-shaped rail having: an arc-shaped inner circumferential wall and outer circumferential wall; a pair of side walls connecting the inner circumferential wall and the outer circumferential wall at side edges thereof; and a slit formed at a center of the inner circumferential wall or the outer circumferential wall along a longitudinal direction,
wherein the arc-shaped rail is formed by bending a ring of a thin metal plate by spinning using a circumferentially divided core so that the arc-shaped rail has a desired inside dimension, and
wherein the manufacturing method comprises:
a first process of forming one of the side walls and one of circumferential wall portions by bending the ring of the thin metal plate by spinning, the circumferential wall portions being portions on both sides of a width direction of the inner circumferential wall or the outer circumferential wall divided by the slit; and
a second process of forming an other one of the side walls and an other one of the circumferential wall portions by spinning using a plurality of cores so as to envelop the plurality of cores, the plurality of cores being obtained by dividing the core in a width direction to not more than a width of the slit.

3. The manufacturing method of the arc-shaped rail according to claim 1, wherein the plurality of cores include a first core, a second core, and a middle core, the first core being placed within a space defined by the one side wall and the one circumferential wall portion formed in the first process, the second core being used for forming the other side wall and the other circumferential wall portion in the second process, and the middle core being placed between the first core and the second core, and
wherein, in the second process, the other side wall and the other circumferential wall portion are formed by bending the ring so as to be along an outer surface of the second core.

4. The manufacturing method of the arc-shaped rail according to claim 2, wherein the plurality of cores include a first core, a second core, and a middle core, the first core being placed within a space defined by the one side wall and the one circumferential wall portion formed in the first process, the second core being used for forming the other side wall and the other circumferential wall portion in the second process, and the middle core being placed between the first core and the second core, and
wherein, in the second process, the other side wall and the other circumferential wall portion are formed by bending the ring so as to be along an outer surface of the second core.

5. An arc-shaped rail manufactured by the manufacturing method according to claim 1, wherein a slider having a roller slides inside the arc-shaped rail.

6. An arc-shaped rail manufactured by the manufacturing method according to claim 2, wherein a slider having a roller slides inside the arc-shaped rail.

7. A manufacturing device that manufactures an arc-shaped rail by bending a ring of a thin metal plate by spinning using a circumferentially divided core, the arc-shaped rail being C-shaped in cross section and having: an arc-shaped inner circumferential wall and outer circumferential wall; a pair of side walls connecting the inner circumferential wall and the outer circumferential wall at side edges thereof; and a slit formed at a center of the inner circumferential wall or the outer circumferential wall along a longitudinal direction, the manufacturing device comprising:
an external die in which the ring is placed;
a core placed so that the ring is sandwiched between the core and the external die; and
a spinning roller movable by an arm mechanism,
wherein the core is divided into a plurality of cores in a width direction,
wherein the side walls and circumferential wall portions are formed by bending the ring by the spinning roller so as to envelop the plurality of cores, the circumferential wall portions being portions on both sides of a width direction of the inner circumferential wall or the outer circumferential wall divided by the slit, and
wherein the plurality of cores are separately extractable from the slit.

8. A core used for manufacturing an arc-shaped rail that is C-shaped in cross section, the arc-shaped rail having: an arc-shaped inner circumferential wall and outer circumferential wall; a pair of side walls connecting the inner circumferential wall and the outer circumferential wall at side edges thereof; and a slit formed at a center of the inner circumferential wall or the outer circumferential wall along a longitudinal direction, the core comprising:
a first core that, after one of the side walls and one of circumferential wall portions are formed, is placed within a space defined by the side wall and the circumferential wall portion, upon forming an other one of the side walls and an other one of the circumferential wall portions, the circumferential wall portions being portions on both sides of a width direction of the inner circumferential wall or the outer circumferential wall divided by the slit;
a second core that is used for forming the other side wall and the other circumferential wall portion; and
a middle core that is placed between the first core and the second core.
